(19) United States
(12) Patent Application Publication
(10) Pub. No.: US 2012/0236018 A1
(43) Pub. Date: Sep. 20, 2012

(54) APPARATUS AND METHOD FOR OPERATING A PORTABLE TERMINAL

(75) Inventor: Woo-Up Kwon, Seoul (KR)

(73) Assignee: SAMSUNG ELECTRONICS CO., LTD., Suwon-si (KR)

(21) Appl. No.: 13/421,687

(22) Filed: Mar. 15, 2012

(30) Foreign Application Priority Data
Mar. 15, 2011 (KR) 10-2011-0022812

(51) Int. Cl. G06F 3/041; G09G 5/02; G09G 5/00; G06F 3/02

(52) U.S. Cl. 345/589; 345/168; 345/649

(57) ABSTRACT

An apparatus and a method provide a user interface in order to operate a portable terminal having a touch screen with only one hand. The method for providing a virtual keypad includes configuring the virtual keypad having at least one control menu according to the composition information of the virtual keypad, and displaying the virtual keypad in a portion of the touch screen according to the composition information of the virtual keypad.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Mar. 15, 2011 and assigned Serial No. 10-2011-0022812, the contents of which are herein incorporated by reference.

### TECHNICAL FIELD

The present disclosure relates to an apparatus and a method for operating a portable terminal, in particular for providing a user interface in order to operate the portable terminal having a touch screen with one hand only.

### BACKGROUND

Due to advances in various technology (such as wired and wireless telecommunication technology; multimedia technology; technology for manufacturing hardware, such as processors, memory etc.; technology for recharging electric power, and the like), the functions of a portable terminal have been much improved. For example, due to the advance of technology related to the portable terminal, products such as a PDA (personal digital assistant), a laptop, a smart phone, a net-book, a mobile internet device (MID), a UMPC (ultra mobile PC), a tablet personal computer and the like have been developed.

In recent times, there has been a significant increase in the number of portable terminals having a touch screen as a major input apparatus instead of a separate keypad. For example, tablet PCs often have a touch screen as a major input apparatus instead of a separate keypad due to the reduced weight and ease of carrying.

As described in detail in the foregoing, the touch screen is used as the major input apparatus in the tablet PC. Due to inconvenience, a separate keypad would not be advantageous in the tablet PC, because a user may need to operate with both hands due to the total size.

Hence, a user interface in a portable terminal having a touch screen that can be operated with only one hand by the user is required.

### SUMMARY

To address the above-discussed deficiencies of the prior art, it is a primary object to provide at least the advantages below. Accordingly, one aspect of the present disclosure is to provide an apparatus and a method for operating a portable terminal with a touch screen.

Another aspect of the present disclosure is to provide an apparatus and a method for providing a user interface with which a user can operate a portable terminal having a touch screen using only one hand.

A further aspect of the present disclosure is to provide an apparatus and a method for providing a virtual keypad service with which a user can operate a portable terminal having a touch screen.

Yet another aspect of the present is to provide an apparatus and a method for configuring a virtual keypad in a portable terminal having a touch screen with compatibility.

According to an embodiment of the present disclosure, a method for providing a virtual keypad in a portable terminal having a touch screen is provided. The method includes configuring the virtual keypad containing at least one control menu according to composition information of the keypad. The method also includes displaying the virtual keypad in a portion of the touch screen according to the composition information of the virtual keypad.

According to an embodiment of the present disclosure, an apparatus for providing a virtual keypad in a portable terminal is provided. The apparatus includes a touch screen. The apparatus also includes a controlling unit configured to configure the virtual keypad having at least one control menu according to composition information of the virtual keypad and display the virtual keypad in a portion of the touch screen according to the composition information of the virtual keypad.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present disclosure will be more apparent from the following detailed description taken in conjunction with the accompanying drawings, in which:

FIG. 1 illustrates a block configuration of a portable terminal according to the present disclosure;

FIG. 2 illustrates a process for configuring a virtual keypad in a portable terminal according to an example of the present disclosure;

FIG. 3 illustrates a process for displaying a virtual keypad in a portable terminal according to an example of the present disclosure;

FIG. 4 illustrates a process for providing virtual keypad service in a portable terminal according to an example of the present disclosure;

FIG. 5 illustrates a process for providing virtual keypad service according to another example of the present disclosure;

FIG. 6 illustrates a configuration of a virtual keypad according to an example of the present disclosure; and

FIGS. 7A and 7B illustrate a configuration of a virtual keypad displayed in a displaying unit of a portable terminal according to an example of the present disclosure.

### DETAILED DESCRIPTION OF THE INVENTION

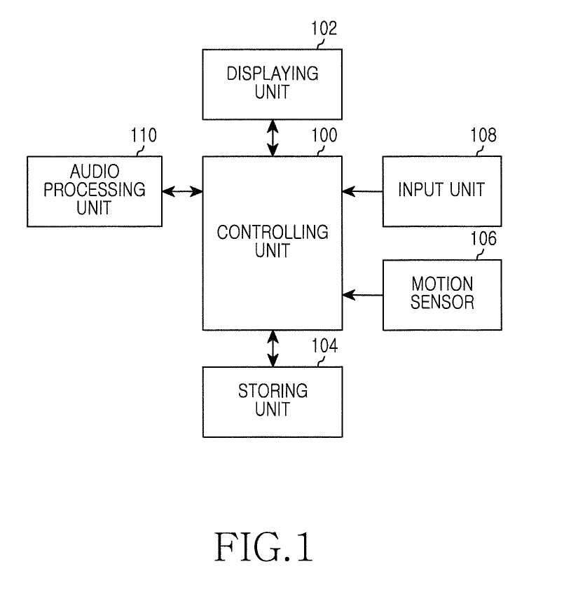

FIGS. 1 through 7B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. Embodiments of the present disclosure will be described herein below with reference to the accompanying drawings. In the following description, well-known functions or constructions are not described in detail since they would obscure the disclosure in unnecessary detail. Terms described below, which are defined considering functions in the present disclosure, can be different depending on user and operator's intention or practice. Therefore, the terms should be defined based on the disclosure throughout this specification. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined based on the disclosure throughout this specification.

Technology for providing a user interface with which a user operates a portable terminal having a touch screen using only one hand will be described below.

In the following, a portable terminal having a touch screen may comprise a PDA, a laptop, a smart phone, a net-book, a mobile internet device, a ultra mobile PC, a tablet personal computer, and the like.

FIG. 1 illustrates a block configuration of a portable terminal according to the present disclosure.

As shown in FIG. 1, a portable terminal may comprise a controlling unit 100, a displaying unit 102, a storing unit 104, a motion sensor 106, an input unit 108, and an audio processing unit 110.

The controlling unit 100 may control the overall operation of the portable terminal.

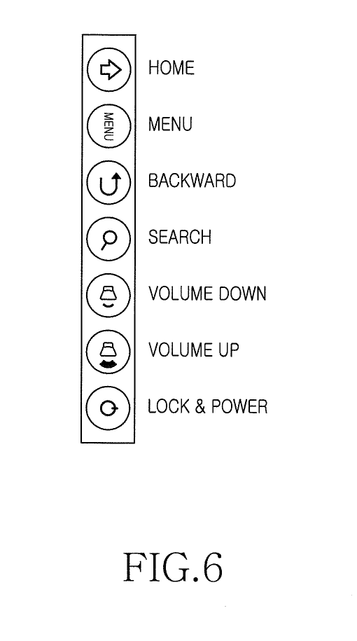

The controlling unit 100 may configure a virtual keypad comprising at least one control menu and control the virtual keypad to be displayed in some area of the displaying unit 102. For example, the controlling unit 100, as shown in FIG. 6, may configure the virtual keypad to include a control menu selected from a group consisting of home, menu, backward, search, volume down and volume down, lock, power, and the like. The controlling unit 100 may regulate the virtual keypad to be displayed at a place where the user designates.

If an event occurs that the virtual keypad should be hidden when the virtual keypad is displayed, the controlling unit 100 can regulate the virtual keypad to be diminished. For example, if an instruction for hiding the virtual keypad is made by the user, the controlling unit 100 can regulate the virtual keypad to be diminished. As another example, if the virtual keypad has not used for a predetermined period of time, the controlling unit 100 can regulate the virtual keypad to be displayed in a diminished size.

As described in detail, if the virtual keypad is displayed in a diminished size by the controlling unit 100, the displaying unit 102 can make the virtual keypad not be displayed in an area where information may be displayed. As another example, the displaying unit 102 can diminish the size of the virtual keypad. As yet another example, the controlling unit 100 can regulate the transparency of the virtual keypad. As still another example, the controlling unit 100 can regulate the size and the transparency of the virtual keypad.

If an event occurs for activating the virtual keypad when the virtual keypad is diminished, the controlling unit 100 can control the diminished virtual keypad to be enlarged. That is, the controlling unit 100 can regulate the virtual keypad to be displayed in the original size, namely the previous size before being diminished. In the above embodiment, the activating event may comprise a instruction by the user to display the virtual keypad.

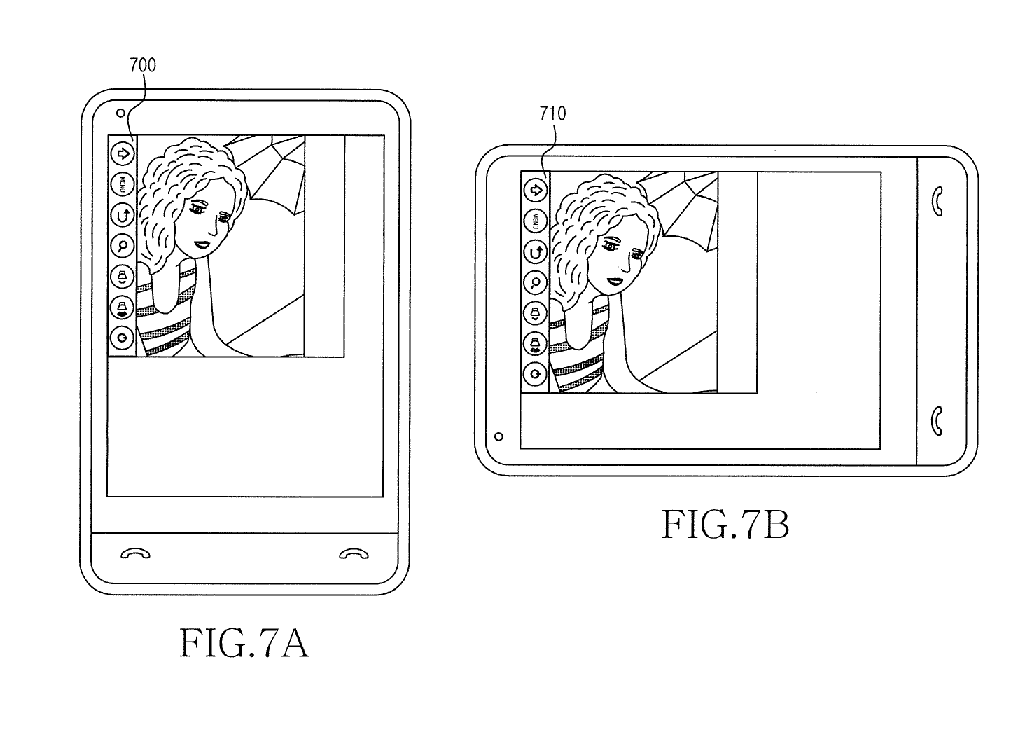

If the rotation of the portable terminal is verified by the motion sensor 106 with the virtual keypad displayed, the controlling unit 100 may control the location of the virtual keypad to be changed according to the rotation of the portable terminal. For example, the controlling unit 100, as shown in FIG. 7A, may control the virtual keypad 700 to be displayed in the top left corner of the displaying unit 102. If the portable terminal is made to be rotated as shown in FIG. 7B, the controlling unit 100 may control the keypad to be displayed in the new top left corner with the portable terminal rotated as shown in FIG. 7B.

The displaying unit 102 may comprise a touch screen configured to execute the function of both display of information and means of input. Hence, the displaying unit 102 may display the state information of the portable terminal, a character input by the user, moving images, still images, and the like, by the control of the controlling unit 100. Also, the displaying unit 102 may provide the controlling unit 100 with touch information by the user.

The displaying unit 102 may display the virtual keypad by the control of the controlling unit 100. And, in an embodiment, the displaying unit 102 may display the virtual keypad in a portion of the edge area of the displaying unit 102 by the control of the controlling unit 100 in order that the user may operate the portable terminal with one hand only. For example, the displaying unit 102 may display the virtual keypad by the control of the controlling unit 100 such that the virtual keypad overlaps on displayed contents. As other example, the displaying unit 102 may display the virtual keypad at an area different from that of the displayed contents.

The storing unit 104 may comprise a program storing unit for storing a program to control the operation of the portable terminal and a data storing unit for storing the data generated during the operation of a program. For example, the storing unit 104 may store the type of the control menu provided from the controlling unit 100 and included in the keypad, and the location information of the keypad.

The motion sensor 106 may detect the movement of the portable terminal. The motion sensor 106 may include a geomagnetic sensor, an accelerator sensor, a gyroscope sensor and the like.

The input unit 108 may provide the controlling unit 100 with the input data generated by the selection of a user. For example, the input unit 106 may include a control button for controlling the portable terminal. As another example, the input unit 106 may be comprised of a keypad for receiving the input data by the user.

The audio processing unit 110 may control the input and output of audio signals.

As described in detail, if the portable terminal provides telecommunication service, the portable terminal may further comprise a telecommunication module. Also, the portable terminal may comprise no motion sensor 106.

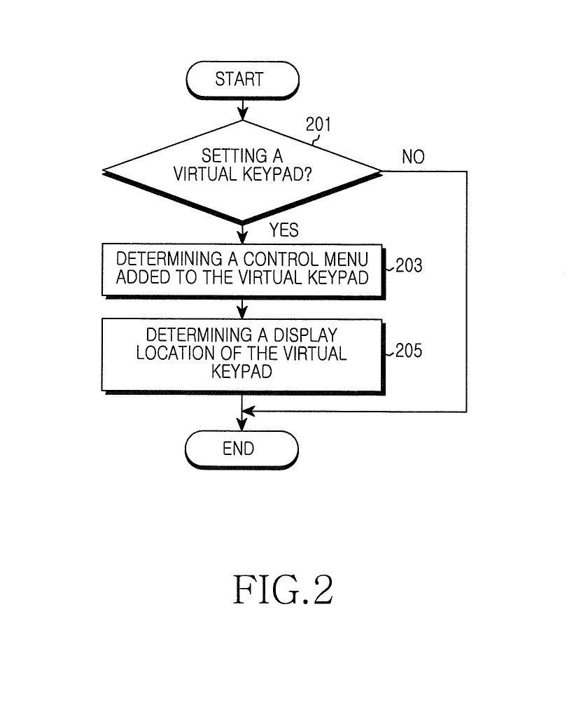

As described in detail, the portable terminal may provide the virtual keypad such that the user can operate all the function of the portable terminal with only one hand. In this embodiment, the virtual keypad may comprise a fixed controlling function only or comprise an adaptive controlling function associated with the user as shown in FIG. 2.

FIG. 2 illustrates a process for configuring a virtual keypad in a portable terminal according to an example of the present disclosure.

Referring to FIG. 2, it may be determined whether a virtual keypad is set or not in a portable terminal at step 201. For example, it may be checked whether a keypad setting menu can be selected in the portable terminal by the user.

If the virtual keypad is not set, the algorithm may be terminated in the portable terminal.

Alternatively, if the virtual keypad is set, at least one control menu added to the virtual keypad of the portable terminal may be determined in step 203. For example, if the setting menu of the virtual keypad is selected, at least one control menu added to the virtual keypad may be displayed in the displaying unit 102 of the portable terminal for the verification of the user. Then, a control menu selected by the user among at least one displayed control menu may be selected to be added to the virtual keypad.

After the control menu added to the virtual keypad is determined, the location where the virtual keypad should be displayed may be determined in the portable terminal in step 205. That is, the display location of the virtual keypad selected by the user may be checked in the portable terminal.

And then, the algorithm may be terminated in the portable terminal.

In the example described above, the control menu included in the virtual keypad and the location of the virtual keypad may be set in the portable terminal. Furthermore, the shape of the virtual keypad, the size of the virtual keypad, the transparency of the virtual keypad and/or the color degree of the virtual keypad may also be set.

In the example described above, the location of the virtual keypad may be determined in the portable terminal, after the control menu included in the virtual keypad is determined.

In another example, the control menu may be determined in the portable terminal, after the location of the virtual keypad is determined.

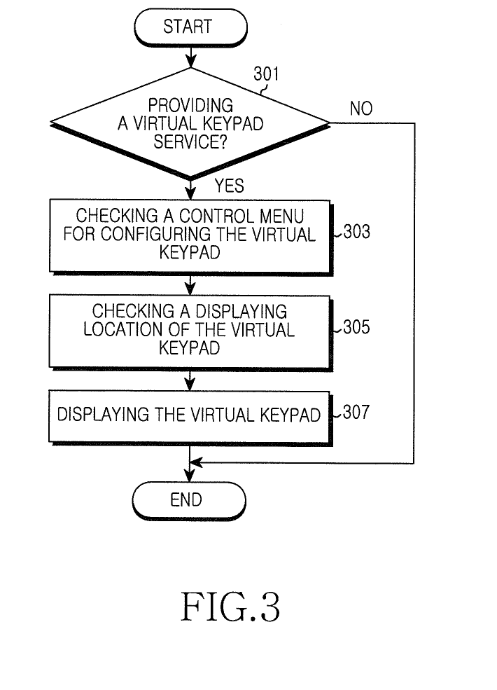

FIG. 3 illustrates a process for displaying a virtual keypad in a portable terminal according to an example of the present disclosure.

Referring to FIG. 3, in step 301, it may be determined whether or not the virtual keypad service is provided in the portable terminal. For example, it may be verified in the portable terminal whether or not the virtual keypad service providing menu is set by the user.

If the virtual keypad service is not provided, the algorithm may be terminated in the portable terminal.

Alternatively, if the virtual keypad service is provided, at least one control menu for configuring the virtual keypad in the portable may be checked in step 303. For example, at least one control menu selected by the user for configuring the virtual keypad may be verified in the portable terminal.

Then, the location where the virtual keypad is to be displayed may be checked in step 305 in the portable terminal. For example, the display location of the virtual terminal selected by the user may be verified in the portable terminal.

After the control menu for configuring the virtual keypad and the location of display are checked, the virtual keypad comprising at least one control menu verified in step 303 may be displayed at the verified location of step 305 by processing step 307. For example, as shown FIG. 7A or FIG. 7B, the virtual keypad 700 or 710 may be displayed in the displaying unit 102 in the portable terminal.

Then, the algorithm may be terminated in the portable terminal.

In the embodiment described above, after the control menu included in the virtual keypad in the portable terminal is verified, the display location of the virtual keypad may be verified. In an embodiment, the verification order may be reversed. That is, the verification of the display location of the virtual keypad and that of the control menu included in the virtual keypad display may be processed in parallel.

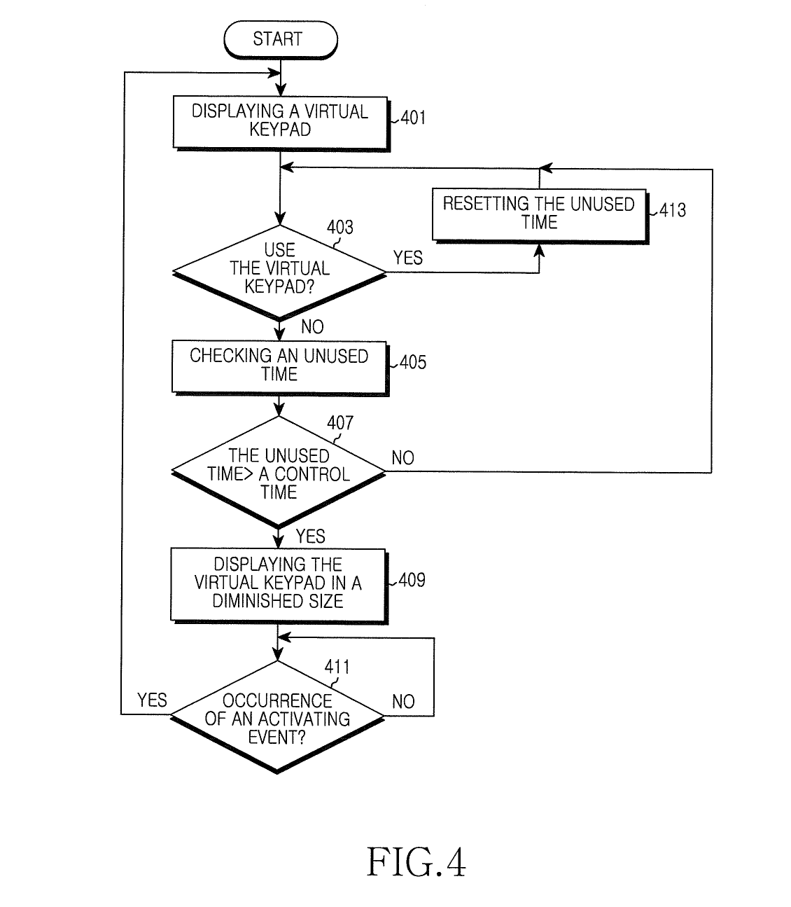

As described in detail, the virtual keypad comprising at least one control menu for the convenience of the user may be displayed in the displaying unit 102 in the portable terminal. The operation of the portable terminal may be controlled before displaying the virtual keypad below, as shown in FIG. 4.

FIG. 4 illustrates a process for providing a virtual keypad service in a portable terminal according to an example of the present disclosure.

Referring to FIG. 4, the virtual keypad may be displayed in the portable terminal in step 401. For example, the virtual keypad 700 or 710 may be displayed in the displaying unit 102 in the portable terminal, as shown in FIG. 7A or FIG. 7B.

Then, in step 403, it may be verified in the portable terminal whether or not the virtual keypad is used.

If the virtual keypad is used, an unused time of the virtual keypad may be reset in the portable terminal in step 413. For example, the unused time may be checked with a timer in the portable terminal. If the virtual keypad is used, the timer may be reset in the portable terminal for resetting the unused time of the virtual keypad. In the above embodiment, the unused time may mean the interval between a moment when the virtual keypad was last used and a moment when the virtual keypad is just used.

Then, in step 403, it may be verified in the portable terminal whether or not the virtual keypad is used. In an embodiment, the display of the virtual keypad may be maintained normally in the portable terminal.

If the virtual keypad is not used, the unused time may be checked in the portable terminal in step 405.

Then, in step 407, the occurrence of a diminishing event of the virtual keypad may be checked in the consideration of the unused time of the virtual keypad. For example, the unused time of the virtual keypad may be compared with a control time in the portable terminal.

If the unused time of the virtual keypad is equal to or less than the control time, the diminishing event of the virtual keypad may be regarded as not occurring in the portable terminal. Therefore, in step 403, it may be verified in the portable terminal whether or not the virtual keypad is used. In an embodiment, the display of the virtual keypad may be maintained in the portable terminal.

Alternatively, if the unused time of the virtual keypad is greater than the control time, the diminishing event of the virtual keypad may be regarded as occurring in the portable terminal. Hence, the virtual keypad may be displayed in a diminished size in the portable terminal in step 408. For example, the virtual keypad is not displayed in the displaying unit 102 in the portable terminal. As another example, the virtual keypad may be diminished in the portable terminal. As yet another example, the transparency of the virtual keypad may be regulated in the portable terminal. As still another example, the size and the transparency of the virtual keypad may be regulated in the portable terminal.

After the virtual keypad is displayed in the diminished size, the occurrence of the activating event may be checked in the portable terminal in step 411. For example, the input of a display instruction of the virtual keypad by the user may be verified in the portable terminal.

If the activating event occurs, the virtual keypad may be displayed in the portable terminal in step 401. That is, the virtual keypad may be displayed in the displaying unit 102 in an enlarged size the same as the original.

Alternatively, if the activating event doesn't occur, the occurrence of the activating event may be checked in the portable in step 411.

In the above-mentioned example, the occurrence of the diminishing event of the virtual keypad may be checked in the portable terminal in the consideration of the unused time.

As another example, the virtual keypad may be displayed in the diminished size, after checking the input of an instruction of the diminished display by the user in the portable terminal.

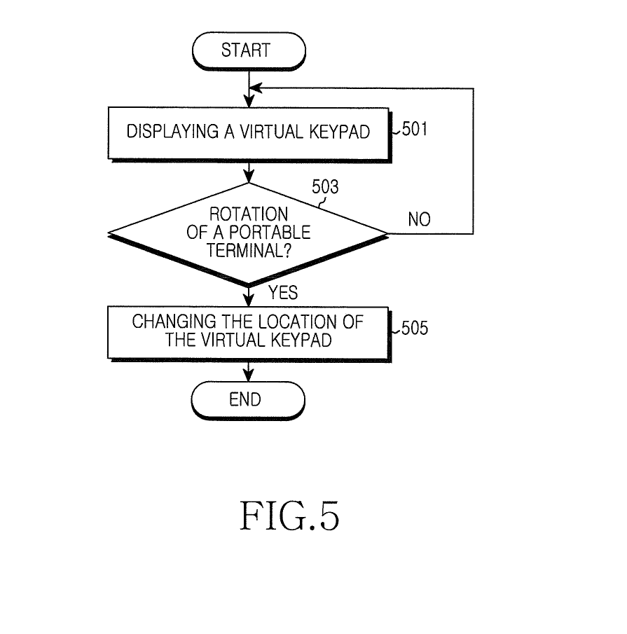

FIG. 5 illustrates a process for providing a virtual keypad service according to another example of the present disclosure.

Referring to FIG. 5, the virtual keypad may be displayed in the portable terminal through step 501. For example, as shown in FIG. 7A, the virtual keypad 700 may be displayed in the displaying unit 102.

Then, in step 503, the rotation of the portable terminal may be checked in the portable terminal. For example, the rotation of the portable terminal may be verified with the motion sensor 106 in the portable terminal.

If the portable terminal doesn't rotate, the display of the virtual terminal may be maintained in the portable terminal in step 501.

Alternatively, if the portable terminal rotates, the location of the virtual terminal may change according to the rotation of the portable terminal in step 505. For example, if the portable terminal rotates from the location shown in FIG. 7A to that shown in FIG. 7B, the virtual keypad 710 may be displayed in the top left corner of the screen of the rotated portable terminal as shown in FIG. 7B.

Then, the algorithm may be ended in the portable terminal.

As described in detail, the virtual keypad having a plural of operation buttons in the portable terminal with a touch screen may be displayed in a part of the screen, which may have an advantage that the user may operate the portable terminal with only one hand regardless of the size of the portable terminal.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method for providing a virtual keypad in a portable terminal with a touch screen, the method comprising:
configuring the virtual keypad having at least one control menu according to composition information of the virtual keypad; and
displaying the virtual keypad in a portion of the touch screen according to the composition information of the virtual keypad.

2. The method of claim 1, wherein the composition information of the virtual keypad comprises at least one of: at least one control menu included in the virtual keypad, a location of the virtual keypad, a shape of the virtual keypad, a size of the virtual keypad, a transparency of the virtual keypad, and a color degree of the virtual keypad.

3. The method of claim 1, wherein displaying the virtual keypad comprises displaying the virtual keypad in an edge area of the touch screen according to the composition information.

4. The method of claim 1, wherein the virtual keypad comprises at least one control menu selected from a group consisting of: home, menu, backward, search, volume up and volume down, and lock & power.

5. The method of claim 1, the method further comprising:
checking an occurrence of a diminishing event after the virtual keypad is displayed; and
displaying the virtual keypad in a diminished size if the diminishing event occurs.

6. The method of claim 5, wherein checking the occurrence of a diminishing event comprises:
checking a time when the virtual keypad is unused continuously after the virtual keypad is displayed; and
comparing the continuously unused time with a control time,
wherein the diminishing event is regarded as occurring if the continuously unused time is longer than the control time.

7. The method of claim 5, wherein checking the occurrence of the diminishing event comprises:
verifying an input of a diminishing instruction of the virtual keypad after the virtual keypad is displayed,
wherein the diminishing event is regarded as occurring if the diminishing instruction of the virtual keypad is input.

8. The method of claim 5, wherein checking the occurrence of the diminishing event comprises:
displaying the virtual keypad in a diminished size by regulating either the size of the virtual keypad or the transparency of the virtual keypad if the diminishing event occurs.

9. The method of claim 5, the method further comprising:
checking an occurrence of an activating event after the virtual keypad is displayed in a diminished size; and
displaying the diminished virtual keypad in an enlarged size the same as the original size.

10. The method of claim 1, the method further comprising:
verifying a rotation of the portable terminal after the virtual keypad is displayed; and
changing the location of the virtual keypad according to the rotation of the portable terminal if the portable terminal rotates.

11. An apparatus for providing a virtual keypad in a virtual terminal, the apparatus comprising:
a touch screen; and
a controlling unit configured to configure a virtual keypad having at least one control menu according to composition information of the virtual keypad and display the virtual keypad in a portion of the touch screen according to the composition information.

12. The apparatus of claim 12, wherein the composition information of the virtual keypad comprises at least one of: a control menu included in the virtual keypad, a location of the virtual keypad, a shape of the virtual keypad, a size of the virtual keypad, a transparency of the virtual keypad, and a color degree of the virtual keypad.

13. The apparatus of claim 11, wherein the controlling unit displays the virtual keypad in an edge area of the touch screen according to the composition information.

14. The apparatus of claim 11, wherein the controlling unit comprises at least one control menu selected from a group consisting of: home, menu, backward, search, volume up and volume down, and lock & power.

15. The apparatus of claim 1, wherein the controlling unit regulates the virtual keypad to be displayed in a diminished size if a diminishing event occurs after the virtual keypad is displayed in the touch screen.

16. The apparatus of claim 15, wherein the controlling unit regards the diminishing event as having occurred if a continuously unused time of the virtual keypad is longer than a control time after the virtual keypad is displayed.

17. The apparatus of claim 15, wherein the controlling unit regards the diminishing event as having occurred if a diminishing instruction of the virtual keypad is input after the virtual keypad is displayed.

18. The apparatus of claim 15, wherein the controlling unit displays the virtual keypad in a diminished size by regulating either a size of the virtual keypad or a transparency of the virtual keypad if the diminishing event occurs.

19. The apparatus of claim 15, wherein the controlling unit displays the diminished virtual keypad in an enlarged size the same as the original size if an activating event occurs after the virtual keypad is displayed in the diminished size.

20. The apparatus of claim 11, wherein the apparatus further comprises a motion sensor and the controlling unit controls the location of the virtual keypad according to the rotation of the portable terminal if the rotation of the portable terminal is detected with the motion sensor after the virtual keypad is displayed.
